(19) United States
(12) Patent Application Publication
(10) Pub. No.: US 2009/0053913 A1
(43) Pub. Date: Feb. 26, 2009

(54) Low profile electrical connector and assembly

(75) Inventor: De-Jin Chen, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/229,630

(22) Filed: Aug. 25, 2008

(30) Foreign Application Priority Data
Aug. 24, 2007 (CN) 200720045517.8

(51) Int. Cl. H01R 12/00

(52) U.S. Cl. 439/81

(57) ABSTRACT

An electrical connector defining a mounting plane adapted to be mounted on a PCB, comprises a dielectric housing and a plurality of socket contacts. The dielectric housing comprises a plurality of passages; each passage defines a mating opening facing the mounting plane. The plurality of socket contacts is respectively secured in the dielectric housing. Each the socket contact comprises a retaining section secured in the passages, a contacting section adapted to engage a contact pin of a complementary connector when the contact pin insert into the passage through the mating opening, and a tail extending out the passage through the mating opening and exposed on the mounting plane.

### BACKGROUND OF THE INVENTION

1. Field of the Invention

The present invention is generally related to the art of electrical connector adapted to mount on a printed circuit board (PCB), and more particularly to an electrical connector having a low profile feature supplied by distinctive contact structure and layout of the contacts in the connector.

2. Description of Related Art

There are a wide variety of electrical connectors are usually used to connect to a PCB. A board mounted electrical connector conventionally includes a dielectric housing which mounts a plurality of contacts. The housing defines a plurality of passages for receiving the contacts, a mounting plane adapted to mount on a PCB, and an opposite mating surface. A complementary connector is generally engaging the electrical connector from the mating surface, so the height above the PCB will be the height of the electrical connector plus the complementary connector.

The related art can refer to the U.S. Pat. No. 6,439,934 issued to Hon Hai on Feb. 12, 2003. An electrical connector (100) for mounting on a PCB (3) includes an insulative housing (1) with a plurality of passageways (13) defined therethrough for receiving a corresponding plurality of electrical contacts (2) therein. The plurality of electrical contacts (2) can be inserted into the passageways (13) from bottom side, and the mounting tail 22 of each electrical contacts remains on the bottom. The mating face of the electrical connector (100) is on the top side.

One of the problems with electrical connector of the character described above centers around the ever-increasing miniaturization of various electronic equipments. The electrical connectors used in such equipment, likewise, are increasingly miniaturized.

Hence, an improved low profile electrical connector is required to overcome the disadvantages of the prior art.

### SUMMARY OF THE INVENTION

Accordingly, an object of the present invention is to provide an improved electrical connector having a low profile feature.

In order to achieve the above-mentioned object, an electrical connector defining a mounting plane adapted to be mounted on a PCB, comprises a dielectric housing and a plurality of socket contacts. The dielectric housing comprises a plurality of passages. Each passage defines a mating opening facing the mounting plane. The plurality of socket contacts are respectively secured in the dielectric housing, each the socket contact comprises a retaining section secured in the passages, a contacting section adapted to engage a contact pin of a complementary connector when the contact pin insert into the passage through the mating opening, and a tail extending out the passage through the mating opening and exposed on the mounting plane.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of an electrical connector of a preferred embodiment of the present invention and a printed circuit board, wherein a socket contact is disassembled;

FIG. 2 is an perspective view of the socket contact of the electrical connector as shown in FIG. 1;

FIG. 3 is a perspective view of the electrical connector as shown in FIG. 1 mounted on the printed circuit board;

FIG. 4 is a perspective view of the electrical connector as shown in FIG. 1 mounted on a circuit board, and a complementary connector having male contacts.

FIG. 5 is a section view of the electrical connector assembly is engaging the complementary connector as shown in FIG. 4.

### DETAILED DESCRIPTION OF THE INVENTION

Reference will now be made in detail to the preferred embodiment of the present invention.

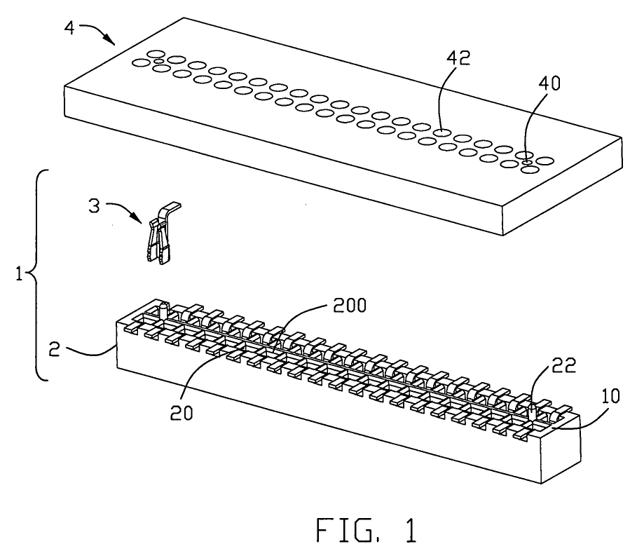

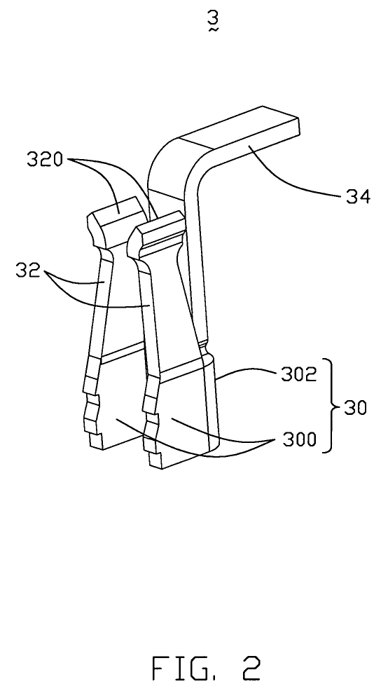

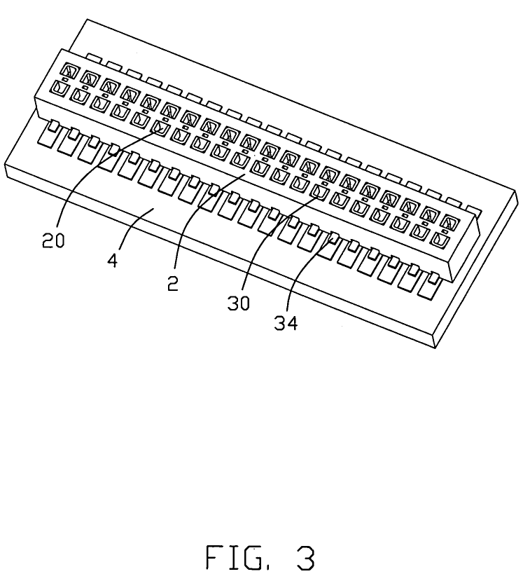

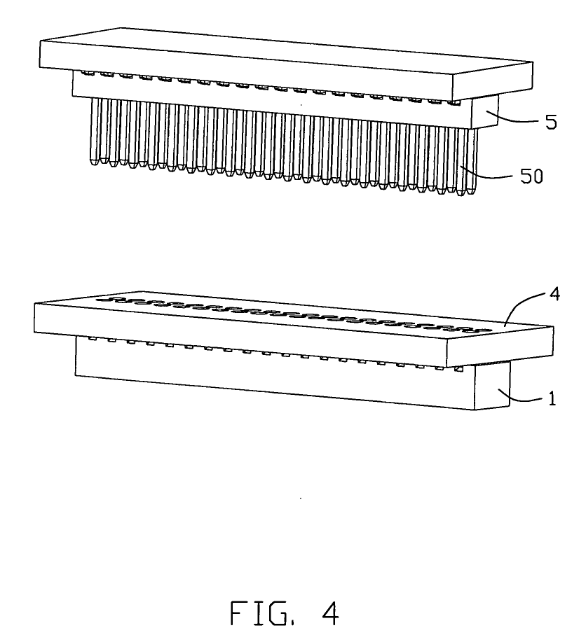

Referring to FIG. 1-5, an electrical connector 1 defining a mounting plane 10 adapted to be mounted on a PCB 4, comprises a dielectric housing 2 and a plurality of socket contacts 3. The dielectric housing 2 comprises a plurality of passages 20 communicating the mounting plane 10 and an opposite back surface (not labeled), each passage defines a mating opening 200 having lead-in section facing and adjacent to the mounting plane. The plurality of passages 20 are arranged in two rows, a pair of posts 22 are sticking on the mounting plane 10 between the two rows of passages 20, in order of align the electrical connector 1 on the PCB 4 when mounting.

The plurality of socket contacts 3 is respectively inserted into the passages 20 from the back surface (not labeled) and respectively secured in the dielectric housing 2. Each the socket contact 3 comprises a retaining section 30 secured in the passages 20, a pair of elastic contacting sections 32 adapted to engage a contact pin 50 of a complementary connector 5 when the contact pin 50 insert into the passage 20 through said mating opening 200, and a tail 34 extending out the passage 20 through the mating opening 200 and exposed on the mounting plane 10 adapted to solder on the PCB 5. Each tail 34 in one row extends parallel to the mounting plane 10 toward a direction far away from the other. For the socket contact 3 is inserted into the passages 20 from the back surface (not labeled) while the tails 34 disposed on the mounting plane 10, when the tails 34 soldered, the housing 2 will be tightly secured on the PCB by the socket contacts 3.

The contacting section 32 of the socket contact 3 defining a guiding section 320 facing the mounting plane 10. The contacting section 32 and the tail 34 are closer to the mounting plane 10 than the retaining section 30 of the socket contact 3. So the contact pin 50 of the complimentary connector 5 will easy to engage the contacting section 32, and give an enough rubbing distance between the contact pin 50 and the contacting section 32, so a good electrical and mechanical connection between the electrical connector 1 and the complementary connector 5 is ensured.

Each passage 30 has a rectangle section parallel to the mounting plane, the retaining section 30 of the socket contact 3 comprises a pair of opposite lock arms 300 and a connecting wall 302 connecting the pair of opposite lock arms 300, the pair of opposite lock arms 300 locked in the passage 20 by resisting an first inner wall (not labeled) of the passage, the connecting wall is resisting an second inner wall (not labeled) of the passage, the second inner wall (not labeled) is opposite to the first inner wall (not labeled).

Specially refer to FIG. 1, The PCB defining a pair of locating holes 40 corresponding to the posts 22 and a plurality of through holes 42 respectively align with the mating openings 200 of said passages 20. The plurality of through holes 42 allow a contact pin 50 of the complimentary connector 5 inserting through and engaging said socket contact 3.

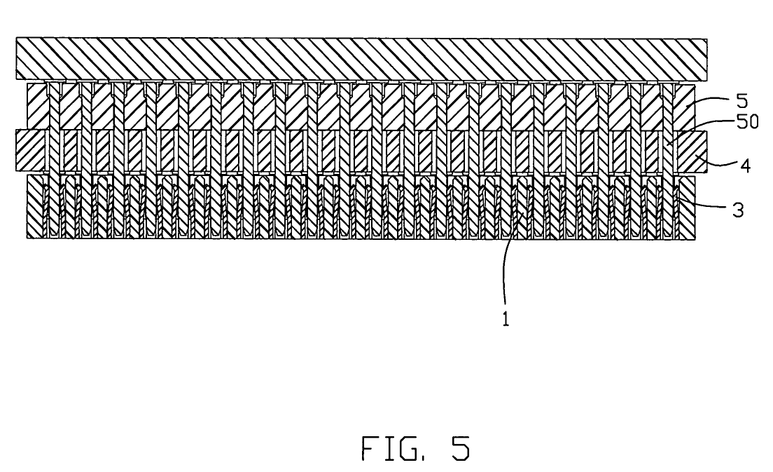

Specially refer to FIG. 5, when the electrical connector 1 is engaging the complementary connector 5, the height above each side of the PCB 4 is shorter than the total height of the electrical connector 1 and the complementary connectors, so a low profile feature is achieved, at the same time as previously described, a good electrical and mechanical connection between the electrical connector 1 and the complementary connector 5 is also maintained.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector defining a mounting plane adapted to be mounted on a PCB (printed circuit board), said electrical connector comprising:
a dielectric housing comprising a plurality of passages, each passage defining a mating opening facing said mounting plane; and
a plurality of socket contacts respectively secured in said dielectric housing, each said socket contact comprising a retaining section secured in said passages, a contacting section adapted to engage a contact pin of a complementary connector when said contact pin insert into said passage through said mating opening, and a tail extending out said passage through the mating opening and exposed on said mounting plane.

2. The electrical connector as described in claim 1, wherein said dielectric housing further comprises at least of a pair of posts sticking on said mounting plane.

3. The electrical connector as described in claim 2, wherein said the passages are through holes communicating said mounting plane and an opposite back surface, said plurality of socket contacts is respectively inserted into said passages from said back surface, each said passages defines lead-in section adjacent to said mounting plane.

4. The electrical connector as described in claim 3, wherein said contacting section of said socket contact is a spring arm defining a guiding section facing said mounting plane, and said contacting section and said tail are closer to the mounting plane than said retaining section of said socket contact.

5. The electrical connector as described in claim 4, wherein said tails are parallel to said mounting plane.

6. The electrical connector as described in claim 5, wherein said each passage has a rectangle section parallel to said mounting plane, said retaining section of said socket contact comprises a pair of opposite lock arms locked in said passage by resisting an first inner wall of said passage.

7. The electrical connector as described in claim 6, wherein said retaining section of said socket contact further comprises a connecting wall connecting said pair of opposite lock arms, said connecting wall is resisting an second inner wall of said passage, said second inner wall is opposite to said first inner wall.

8. An electrical connector assembly comprising an electrical connector comprising:
a PCB defining a plurality of through holes therein; and
an electrical connector defining a mounting plane adapted to be mounted on said PCB, said electrical connector comprising:
a dielectric housing comprising a plurality of passages, each passage defining a mating opening facing said mounting plane and align with one of said through holes in said PCB allowing a contact pin of a complimentary connector inserting therein through said through hole; and
a plurality of socket contacts respectively secured in said dielectric housing, each said socket contact comprising a retaining section secured in said passages, a contacting section adapted to engage a contact pin of a complementary connector when said contact pin insert into said passage, and a tail extending out said passage through the mating opening and exposed on said mounting plane.

9. The electrical connector assembly as described in claim 8, wherein said dielectric housing further comprises at least of a pair of posts sticking on said mounting plane.

10. The electrical connector assembly as described in claim 9, wherein said the passages are through holes communicating said mounting plane and an opposite back surface, said plurality of socket contacts is respectively inserted into said passages from said back surface, each said passages defines lead-in section adjacent to said mounting plane.

11. The electrical connector assembly as described in claim 10, wherein said contacting section of said socket contact is a spring arm defining a guiding section facing said mounting plane, and said contacting section and said tail are closer to the mounting plane than said retaining section of said socket contact.

12. The electrical connector assembly as described in claim 11, wherein said each passage has a rectangle section parallel to said mounting plane, said retaining section of said socket contact comprises a pair of opposite lock arms locked in said passage by resisting an first inner wall of said passage.

13. The electrical connector assembly as described in claim 12, wherein said retaining section of said socket contact further comprises a connecting wall connecting said pair of opposite lock arms, said connecting wall is resisting an second inner wall of said passage, said second inner wall is opposite to said first inner wall.

14. An electrical connector assembly comprising:
a printed circuit board defining opposite first and second surfaces;
a first connector having a first insulative housing seated upon the first surface and defining a plurality of first passageways extending through a bottom face of the first housing;
a plurality of first contacts disposed in the first housing;
a second connector having a second insulative housing seated upon the second surface and defining a plurality of second contacts extending from the second housing through the printed circuit board and into the corresponding first passageways, and respectively mechanically and electrically engaged with the corresponding first contacts.

15. The electrical connector assembly as claimed in claim 14, wherein the printed circuit board defines a plurality of through holes in alignment with the corresponding first passageways, respectively, through which said second contacts extend.

16. The electrical connector assembly as claimed in claim 14, wherein said first passageways extend through a top face of the first housing for allowing downward assembling the second connector to the first connector.

17. The electrical connector assembly as claimed in claim 14, wherein the second contacts of said second connector are soldered upon another printed circuit board which is parallel to the printed circuit board.
